(19) United States
(12) Patent Application Publication
(10) Pub. No.: US 2006/0054390 A1
(43) Pub. Date: Mar. 16, 2006

(54) LADDER SECURING DEVICE

(76) Inventor: Stephen Win Ray, Coffs Harbour NSW2450 (AU)

Correspondence Address: MARTIN & HENSON, P.C., 9250 W 5TH AVENUE, SUITE 200, LAKEWOOD, CO, 80226, US

(21) Appl. No.: 11/161,779

(22) Filed: Aug. 16, 2005

(30) Foreign Application Priority Data
Aug. 16, 2004 (AU) AU 2004203643

(51) Int. Cl. E06C 7/42

(52) U.S. Cl. 182/107

(57) ABSTRACT

Ladder securing device comprising a bracket and building structure engagement means. The bracket has a ladder clamping means operative to clamp the device to a stile of a ladder. The bracket has a first clamping surface operative to abut against a first side of the stile and a second, movable clamping surface operative to adjustably clamp the stile by moving the second clamping surface towards the first clamping surface so that the second clamp surface abuts a second side of the stile spaced from the first side of the stile. The building structure engagement means is adapted to engage the device with a building structure. The structure engagement means including at least one arm with an engagement surface at least a portion of which extends downwardly in a plane transverse to the longitudinal axis of the bracket to engage a surface of the structure facing in a direction opposite to the side of the structure facing the ladder. The at least one arm terminates at a point that lies in a plane parallel to, but slightly offset from, a plane in which the first clamping surface lies, so that a thin-walled_feature of the building structure can be secured between the stile and the at least one arm.

### FIELD OF THE INVENTION

This invention relates to a device for securing a ladder to a building or other structure. More particularly, this invention relates to a device for securing a ladder, single or extension, to a rainwater gutter, box gutter, parapet, or wooden or metal building frame.

### BACKGROUND

The following references to and descriptions of prior proposals or products are not intended to be, and are not to be construed as, statements or admissions of what is widely known in the art.

In commercial cleaning operations, workers are routinely required to clean a large number of rainwater gutters. The workers are typically supplied with scaffolds, ladders, a “cherry picker” and a large trailer mounted vacuum cleaner. In many situations, access to the gutters is restricted and only a ladder can be used.

Work safety regulations in some jurisdictions require that ladders be secured and, in the case of guttering, the only available fixing point is typically the internal brackets securing the gutter to the fascia board at the eaves. The ladder can be attached to the bracket(s) by rope. In the school context, demountable class rooms may have a virtually flat roof to which are fitted box gutters with no brackets to which a ladder can be fixed.

Common safety problems occurring with ladders involve the ladder sliding across the gutter in a lateral direction and dropping to the ground. This can be caused by a gust of wind, or by a person or animal bumping into the bottom of the ladder. Probably the greatest danger occurs when a person steps on or off the ladder onto a roof. With one foot on the ladder and one foot on the roof the centre of gravity of the person moves outside of the stiles of the ladder with the potential to cause the ladder to slide laterally.

A number of devices have been described which have a bar or plate, wider than the ladder, which is placed inside the rainwater gutter. The ends of these devices protrude above the gutter and outside of the ladder stiles to prevent the ladder from sliding laterally. The drawback to a device of this nature is the need to climb the ladder to place the device in the gutter and then re-position the ladder.

U.S. Pat. No. 5,383,533 describes a ladder clamping tool comprising a standard clamp device which a worker can use to manually clamp a stile of the ladder to the external wall of a gutter. Such an arrangement is dangerous due to the flexibility of the external gutter wall. The clamp relies on flexion of the external gutter wall to hold the clamp in place under tension. Such a clamp device has the potential to slip loose and prove ineffective, possibly resulting in injury to the worker.

### SUMMARY OF THE DISCLOSURE

One aspect of the disclosed embodiments, then, the provision of a new and useful device for releasably securing a ladder, single or extension, inclined to rest against a horizontal rainwater gutter attached to the eaves of a roof.

According to one of the exemplary embodiments, then, a ladder securing device is provided that may comprise:
(a) a bracket with ladder clamping means operative to clamp the device to a stile of a ladder, the bracket having a first surface operative to abut against a first surface of the stile and a second, axially movable surface operative to adjustably clamp the stile by moving towards the first surface into abutment with a second surface of the stile; and
(b) structure engagement means to attach the device to a building structure, the structure engagement means including an arm extending at an angle relative to the longitudinal axis of the bracket and having an engagement surface facing in the same general direction as the first surface of the ladder clamping means.

In another embodiment, the ladder securing device may comprise:
(a) a bracket with ladder clamping means operative to clamp the device to a stile of a ladder, the bracket having a first clamping surface operative to abut against a first side of the stile and a second, movable clamping surface operative to adjustably clamp the stile by moving the second clamping surface towards the first clamping surface so that the second clamp surface abuts a second side of the stile spaced from the first side of the stile; and
(b) structure engagement means to engage the device with a building structure, the structure engagement means including at least one arm with an engagement surface having an at least a portion of which extends downwardly in a plane transverse to the longitudinal axis of the bracket to engage a surface of the structure facing in a direction opposite to the side of the structure facing the ladder;
wherein the at least one arm terminates at a point that lies in a plane parallel to, but slightly offset from, a plane in which the first clamping surface lies, so that a thin-walled_feature of the building structure can be secured between the stile and the at least one arm.

The ladder securing device preferably includes a “U” shaped bracket with hook shaped claws attached to both ends and to the underside of the bracket. The claws are preferably so shaped and positioned as to engage the rolled bead of most sheet metal rainwater gutters. The claws are preferably covered with a nonabrasive surface such as an elastomer coating or sleeve. Where the claws are made of metal, such a protective coating or sleeve may also advantageously protect the claws against corrosion or physical wear and fatigue.

The “U” bracket is sufficiently wide to straddle one or each of the vertical legs (stiles) of one side of a ladder and is then moved laterally such that a right angled projection on the inside of the “U” bracket is positioned adjacent to the resting face of the ladder. A clamping screw passes through and engages with an internally threaded socket at the bottom of the “U”, and is in line with the right angled projection. This screw on being turned clamps the ladder stile to the the projection and in doing so pulls the claws into the bead of the gutter.

When used with an extension ladder, the extreme end claws engage with the gutter but the “U” bracket is clamped to the stile of the extendable section of the ladder.

When a single ladder rests against the gutter, the inner claws engage the bead, this also applies when the extended section of an extension ladder rests against the gutter.

Because of the flexibility of roll formed sheet metal rainwater gutters it is desirable that the device is securely clamped to the ladder stile, then even if the claws become loose, by whatever cause, as long as they remain within the bead, the ladder cannot slide laterally, also the device surrounds the ladder stile on both sides ensuring the ladder cannot slip out of the device.

Whilst the above device caters for most residential buildings use, a simple addition renders it suitable for attachment to box gutters, walls, parapets and wooden or metal building frames.

This addition consists of a short square guide tube attached to the “U” bracket on the leg opposite to the internal projection. In the preferred embodiment this would be by welding but could also be by riveting or bolting to the “U” bracket. The guide tube has a threaded socket on its upper side through which a clamping screw protrudes to the inside. A square bar, or tube, fits loosely inside the guide tube and may slide axially within it. This slide bar has at one end a foot welded at right angles to its axis, the foot protruding to one side. The foot normally projects downwards to hook over a parapet wall or building frame, but can be inserted in the guide tube to project to either side or upwards. The clamp screw locks the slide bar within the guide tube when it has been adjusted to touch the wall or frame against which the ladder rests. The ladder clamping screw, having been left loose enough on the ladder style to enable the device to slide downwards until the claws rest on the wall or frame, is finally tightened on the stile, imposing tension on the slide bar and spring in the “U” frame.

The device described is configured in left handed arrangement, but could equally be right handed.

The device is currently made as a steel fabrication, but could, with suitable modifications, be made of other metals, cast or formed, or of high strength reinforced plastics, or a combination of both.

### DESCRIPTION OF THE DRAWINGS

These and other aspects the embodiments disclosed will become more readily apparent to those of ordinary skill in the art from the following non-limiting description of the preferred forms of embodiment thereof as illustrated in the following drawings:

FIG. 1 is an elevation view of a ladder securing device showing its engagement with a typical rainwater gutter using the outer claws, and it being clamped to an extension ladder in a shortened mode;

FIG. 2 is a top view of the ladder securing device shown in FIG. 1;

FIG. 3 is an elevation view of the ladder securing device showing its engagement with another typical rainwater gutter, using the inner claws and being clamped to a single ladder, or to the stile of an extension ladder in an extended mode;

FIG. 4 is a top view of the ladder securing device shown in FIG. 3;

FIG. 5 is an elevation view of the ladder securing device shown in FIG. 1, enhanced with an extendable arm for engagement with a building frame and being clamped to an extension ladder in the shortened mode;

FIG. 6 is a top view of the ladder securing device shown in FIG. 5;

FIG. 7 is an elevation view of the ladder securing device shown in FIG. 1, enhanced with the extendable arm for engagement with a parapet wall and being clamped to a single ladder, or to the stile of an extension of a ladder in an extended mode;

FIG. 8 is a top plan view of the ladder securing device shown in FIG. 7; and

FIG. 9 is an elevation view of the ladder securing device shown in FIG. 1, enhanced with the extendable arm, as a strut, for engagement against a fascia board to prevent excessive flexing of the gutter; e.g. when roof tilers carry loads such as pointing mortar buckets up the ladder. FIG. 9 shows a single ladder, but the device may also be used on an extension ladder in shortened mode.

### DETAILED DESCRIPTION OF PREFERRED EMBODIMENT

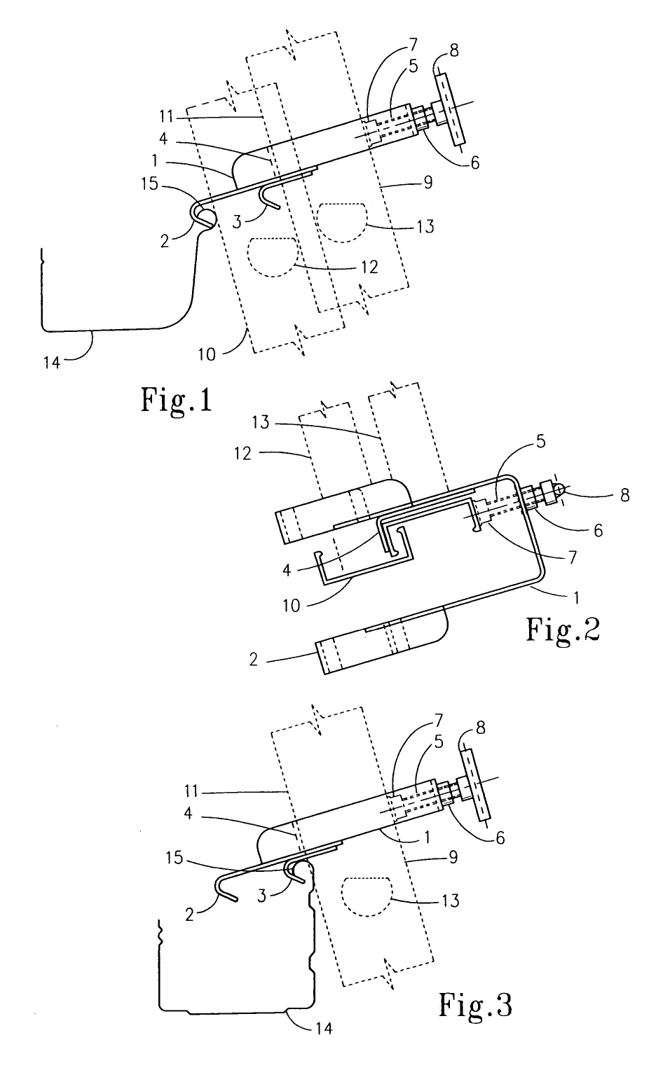

Referring to the drawings, FIGS. 1 and 2 show the ladder securing device comprising a “U” shaped bracket 1 with outer claws 2 and inner claws 3 on the underside of each end of the bracket. A right angled projection 4 on the inside of bracket 1 is clamped against a face 11 of the ladder stile 9 by means of a clamping screw 5 passing through, and engaged with, internally threaded socket 6 which is part of the bracket 1. The clamping screw 5 has at its inner end against ladder stile 9 a clamping pad 7. The pad 7 is fixed to screw 5 providing an enlarged area compared to the screw diameter and may, or may not, have a face capable of rotation, but not swivelling. The outer end of screw 5 has fixed to it a means of rotating it with a person's fingers. A tee bar 8 is shown, but wings as in a wing nut, or a knob with flutes to suit the fingers could also be used.

An extension ladder in 2 parts consisting of stiles (uprights) 9 and 10 with rungs 12 and 13 horizontally connected to further stiles (not shown) is inclined to rest against a substantially horizontal rainwater gutter 14 at the eaves of a roof. The profile of the gutter 14 includes a beaded upper edge 15 against which the ladder stile 10 rests, and into which the outer claws 2, at both ends of the bracket 1, are engaged.

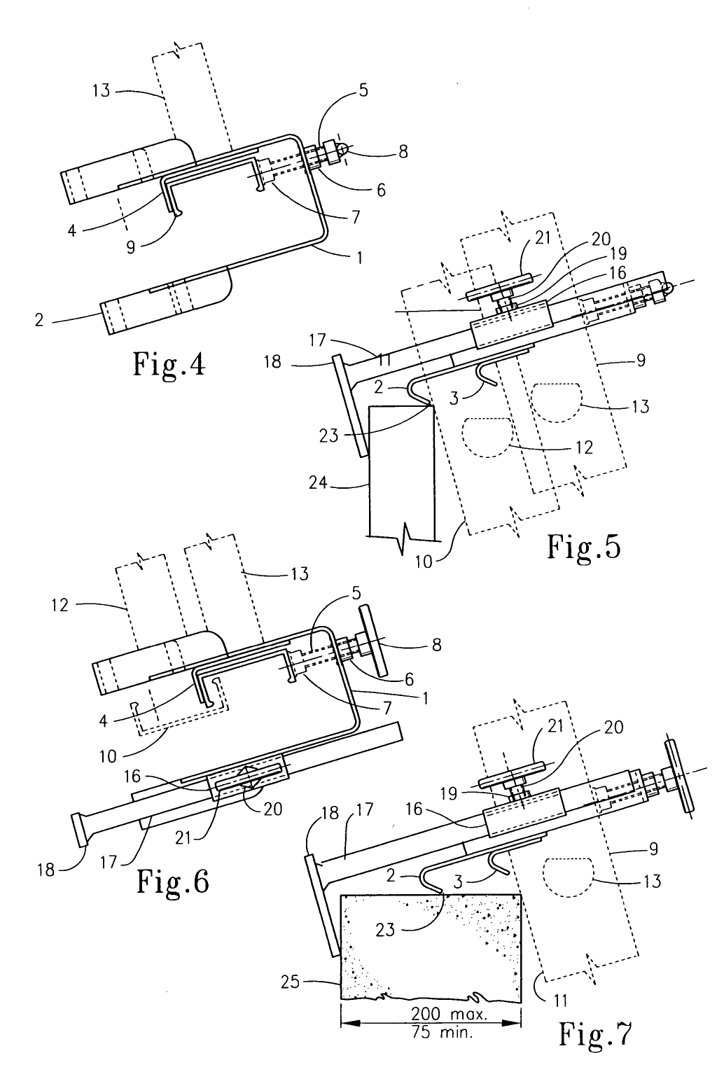

FIGS. 3 and 4 show the device of FIG. 1 just before being clamped to ladder stile 9 (note the gap between stile 9 and the right angled projection 4). The stile 9 is of a single ladder, or the extendable section of an extension ladder, and is shown inclined to rest against the gutter 14 with inner claws 3, at both ends of the bracket 1, engaged within the beaded profile 15.

On fully tightening screw 5 of the device, the clamping face 11 of stile 9 is brought up against projection 4 and the claws 3 pull into the bead 15. The projection 4 keeps the device perpendicular to the ladder stile 9.

In operation, the ladder style 10 is lent against the gutter 14 with the rung 12 nearest the gutter 14 positioned below, level or at least 100 mm above the beaded upper edge 15 to leave space for the device to be placed immediately above the upper edge 15, but clear of the rungs 12, 13. With the claws 3 pointing downwards, the device is placed around the left hand style 10 so that the bracket 1 straddles the style 9. The device is pulled backwards away from the gutter 14 so that the claws 3 hook into the lip of the beaded upper edge 15. The device is then slid to the left so that the projection 4 fits behind the style 9. The locking screw 5 is then tightened by turning clockwise to clamp the style 9 against the projection or locating tab 4. The device is removed by turning the locking screw 5 anti-clockwise to loosen its grip on the style 9. The device may be slid to the right and pushed towards the gutter to release the claws 3 from the upper edge 15. The device may then be removed from the style 9 and re-applied to the ladder once it has been relocated to a different position against the building structure, if required.

FIGS. 5 and 6 show the device of FIG. 1 with the addition of an enhancement enabling the device to engage with box gutters, parapet walls and metal or wooden building frames.

The enhancement consists of a short square guide tube 16 welded, or otherwise attached, to bracket 1 on its outside surface and on the opposite leg to leg of bracket 1 attached to the clamping screw 5. A square inner tube or bar 17, fits loosely inside the guide tube 16 and slides axially within it. The bar 17 has a foot 18 welded on one end and is shown projecting downwards and hooked over a building frame 24 with the outer hook 2 resting on the frame 24 at a frame location 23 on the top surface of the frame 24. The inner tube 17 is retained in this position by means of a clamping screw 20 acting with and through an internally threaded socket 19 which is part of the guide tube 16. Clamping screw 20 is turned manually by its tee bar 21 integrally formed with the clamping screw 20. The clamp screw 5 of the principal device shown in FIG. 1 locks the whole device 1 and the frame 24 to the ladder stile 9, and is shown with an extension ladder in the unextended mode.

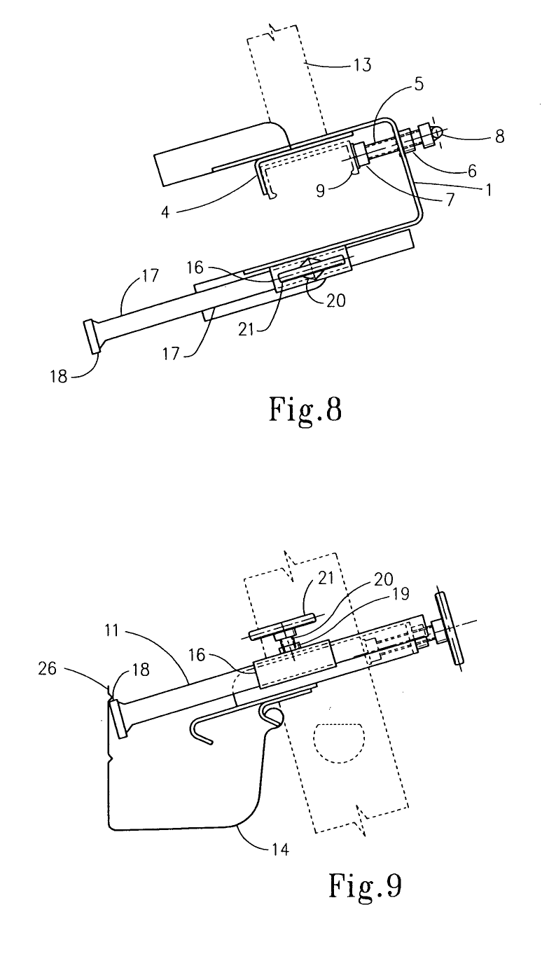

FIGS. 7 and 8 show the enhanced device of FIG. 3 clamped to the stile 9 of a single ladder or the extendable section of an extension ladder, and is shown inclined against a parapet wall 25 with outer claws 2 resting on the top of the wall at 23. With foot 18 of sliding tube 17 tight against the far edge of the wall of parapet wall 25, the clamp screw 20 is tightened, clamping sliding tube 17 within the guide tube 16. Tightening clamp screw 5 of the principal device 1 locks the whole device 1 and the parapet wall 25 to the ladder stile 9.

FIG. 9 shows the enhanced device of FIG. 3 with sliding bar 17 acting as a strut pushing the outer face of foot 18 against a fascia board 26 thereby reducing the deflecting force of the ladder against the typically flexible rainwater gutter 14. The foot 18 is orientated with its longer leg turned inwards and parallel with the top edge of the gutter to more closely follow the profile of the fascia board 26.

Although the present invention has been described hereinbefore in terms of the presently preferred forms of embodiments with respect to or embodied in a device for securing a ladder to rainwater guttering and a parapet wall, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

Throughout the specification and claims the word “comprise” and its derivatives is intended to have an inclusive rather than exclusive meaning unless the context requires otherwise.

What is claimed is:

1. A ladder securing device comprising:
(a) a bracket with ladder clamping means operative to clamp said device to a stile of a ladder, said bracket having a first surface operative to abut against a first surface of said stile and a second, axially movable surface operative to adjustably clamp said stile by moving towards said first surface into abutment with a second surface of said stile; and
(b) structure engagement means to attach said device to a building structure, said structure engagement means including an arm extending at an angle relative to the longitudinal axis of said bracket and having an engagement surface facing in the same general direction as said first surface of said ladder clamping means.

2. A ladder securing device according to claim 1, wherein said structure engagement means is independently adjustable to clamp said structure to said device already clamped to said ladder stile.

3. A ladder securing device according to claim 2, wherein said structure engagement means includes a sliding clamp comprising a tube or bar axially slidable within a guide tube.

4. A ladder securing device according to claim 3, wherein the axis of said tube or bar is aligned parallel to said bracket longitudinal axis.

5. A ladder securing device according to claim 3, wherein said tube or bar is adjustable and has a foot portion at its free end capable of being hooked over a frame or parapet wall.

6. A ladder securing device according to claim 1, wherein said bracket is “U” shaped and operative to straddle and be clamped separately to said stile.

7. A ladder securing device according to claim 6, wherein said structure engagement means includes one or more claws on said bracket which is or are operative to engage with the bead of a rainwater gutter.

8. A ladder securing device according to claim 7, wherein said one or more gutter engaging claws are attached to each end of a cable or chain straddling said stile and are constrained by said “U” bracket clamped to the stile, and tensioned against the gutter.

9. A ladder securing device comprising:
(a) a bracket with ladder clamping means operative to clamp said device to a stile of a ladder, said bracket having a first clamping surface operative to abut against a first side of said stile and a second, movable clamping surface operative to adjustably clamp said stile by moving said second clamping surface towards said first clamping surface so that said second clamp surface abuts a second side of said stile spaced from said first side of said stile; and
(b) structure engagement means to engage said device with a building structure, said structure engagement means including at least one arm with an engagement surface at least a portion of which extends downwardly in a plane transverse to the longitudinal axis of said bracket to engage a surface of said structure facing in a direction opposite to the side of the structure facing said ladder;
wherein said at least one arm terminates at a point that lies in a plane parallel to, but slightly offset from, a plane in which said first clamping surface lies, so that a thin-walled feature of said building structure can be secured between said stile and said at least one arm.

10. A ladder securing device according to claim 9, wherein said structure engagement means includes a pair of claws alternatively engageable to the bead of a rainwater gutter and serially spaced in the direction of the longitudinal axis of said bracket.

11. A ladder securing device according to claim 9, wherein said structure engagement means further includes a sliding clamp comprising a tube or bar axially slidable within a guide tube.

12. A ladder securing device according to claim 11, wherein the axis of said tube or bar is aligned parallel to said bracket longitudinal axis.

13. A ladder securing device according to claim 9, wherein said bracket is U-shaped with a pair of parallel first and second elongate arms.

14. A ladder securing device according to claim 13, wherein said first elongate arm supports said first clamping surface.

15. A ladder securing device according to claim 13, wherein said second elongate arm supports said sliding clamp.

16. A ladder securing device according to claim 13, wherein said device includes two pairs of claws, a first pair of claws operative to engage a gutter bead when said device is clamped to a ladder presenting a single stile and a second pair of claws to engage a gutter bead when said device is clamped to a ladder presenting a pair of overlapping stiles in an extension ladder.
